(19) United States
(12) Patent Application Publication
(10) Pub. No.: US 2025/0036958 A1
(43) Pub. Date: Jan. 30, 2025

(54) TRAINING GENERATIVE NEURAL NETWORKS THROUGH REINFORCED SELF-TRAINING

(71) Applicant: DeepMind Technologies Limited, London (GB)

(72) Inventors: Caglar Gulcehre, Lausanne (CH); Thomas Le Paine, London (GB); Srivatsan Srinivasan, London (GB); Ksenia Konyushkova, London (GB); Lotte Petronella Jacoba Weerts, London (GB); Abhishek Sharma, Sunnyvale, CA (US); Aditya Siddhant, Brooklyn, NY (US); Orhan Firat, Mountain View, CA (US)

(21) Appl. No.: 18/358,920

(22) Filed: Jul. 25, 2023

(51) Int. Cl. G06N 3/092; G06N 3/0475

(52) U.S. Cl. CPC G06N 3/092; G06N 3/0475

(57) ABSTRACT

Methods, systems, and apparatus, including computer programs encoded on computer storage media, for training a generative neural network. One of the methods includes training a generative neural network by performing a sequence of a plurality training stages each generating an expanded training data set. The method also involves performing a sequence of improve steps, each comprising training the generative neural network on the training examples in a corresponding subset of the expanded training data set.

### BACKGROUND

This specification relates to training machine learning models, e.g., neural networks. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes a system that fine-tunes a generative neural network in an offline manner using a reward function.

In one aspect there is described a method performed by one or more computers that involves receiving a training data set for training a generative neural network. The generative neural network has a plurality of parameters and is configured to receive as input a context input, and to process the network input in accordance with the network parameters to generate an output example. The training data set comprises a plurality of training context inputs.

The method involves training the generative neural network starting from initial values of the network parameters by performing a sequence of a plurality training stages. The training comprises, for each training stage, generating an expanded training data set for the training stage. This comprises, for each training context input in a subset of the training context inputs in the training data set, processing the training context input using the generative neural network and in accordance with current values of the network parameters as of the training stage to generate a set of one or more output examples. For each training context input in the subset of the training context inputs in the training data set and for each output example in the set, a respective training example is generated that comprises the training context input and the output example. For each respective training example, the training context input and the output example in the training example is processed using a reward function to generate a reward score for the training example. The respective training examples are included in the expanded training data set.

The method also involves performing a sequence of one or more improve steps. Performing each improve step comprises training the generative neural network on the training examples in a corresponding subset of the expanded training data set using the reward scores for the training examples in the corresponding subset.

The method can be implemented in a parallel processing system comprising a plurality of sets of hardware devices. Each set of hardware devices comprises one or more hardware computing devices, and the sets of hardware devices are configured to operate in parallel. The method can then involve maintaining a respective instance of the generative neural network on each of the sets of hardware devices. Generating the expanded training data set for the training stage then further comprises apportioning each training context input in the subset of the training context inputs to a respective one of the sets of hardware devices, and processing each training context input using the generative neural network on the respective set of one or more hardware devices to generate a respective one of the output examples. The set of output examples comprises a plurality of output examples generated by processing the training context inputs in parallel using the plurality of sets of hardware devices.

Particular embodiments of the subject matter described in this specification can be implemented so as to realize one or more of the following advantages.

This specification describes techniques for fine-tuning a generative neural network using a reward function. Some conventional techniques fine tune based on the reward function using online reinforcement learning, but this involves frequent sampling from the generative neural network and scoring with the reward function. When the generative neural network has a large number of parameters, e.g., billions of parameters, this can be slow and computationally demanding. The described techniques enable the training of an initially trained (pre-trained) generative neural network to be parallelized across multiple hardware computing devices. More specifically implementations of the described techniques use offline learning and divide the training into two parts, a “grow” part that involves sampling from the generative neural network model, and an “improve” part that involves further training (fine tuning) the model, in a way that allows the computationally intensive “grow” part to be parallelized. In general fine tuning can refer to training the model with less computation than the initial training, e.g., training with a reduced number of processor operations, e.g., by training only part of the model such as just the uppermost layer(s), or by performing fewer iterative adjustments of the parameters, or by training using fewer training examples.

In implementations, the generative neural network generates an output example by processing a context input that defines characteristics, e.g., the content, of the output example, such as a natural language, image, audio, video or robot control output example. In implementations parallelizing the sampling can also involve assigning a batch of context inputs to each of the hardware computing devices.

Compared to other approaches for incorporating reward functions into the training of a generative neural network, the described approach has a significantly reduced computational burden because generating new samples and scoring the new samples is performed offline, i.e., without requiring acquiring new context inputs and in a separate step of the training process from updating the parameters of the model. This allows the system to amortize the computational cost of sampling from the generative neural network across multiple model update steps. Moreover, performing the training in the offline manner described in this specification allows the system to parallelize sampling from the generative neural network, significantly decreasing the latency of the training process. In particular, because the “grow step” in which the system needs to sample from the generative neural network is performed offline and separately from the “improve” step, the system can generate a large number of model samples in parallel by distributing the sampling across multiple sets of one or more hardware devices.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network training system.

FIG. 2 is a flow diagram of an example process for training a generative neural network.

FIG. 3 is a flow diagram of an example process for performing a training stage.

FIG. 4 is a flow diagram of an example process for performing an improve step.

FIG. 5 shows the progression of the training of the neural network.

Like reference numbers and designations in the various drawings indicate like elements.

### DETAILED DESCRIPTION

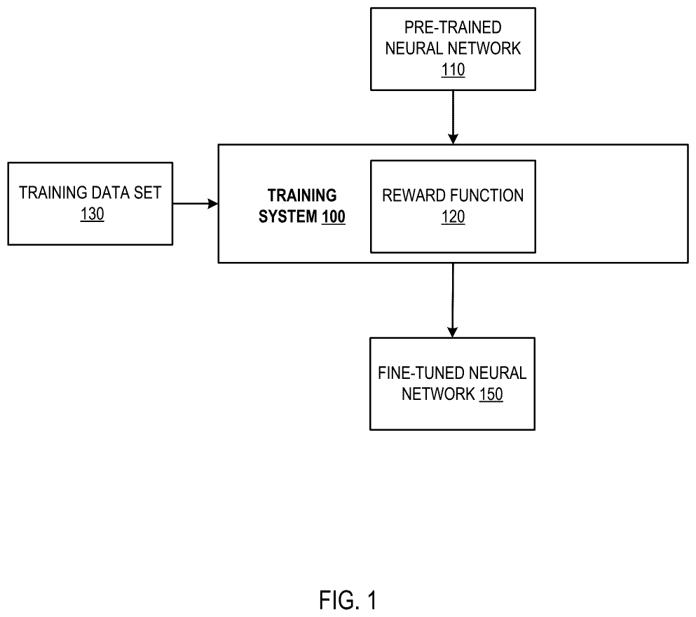

FIG. 1 shows an example neural network training system 100. The neural network training system 100 is an example of a system implemented as computer programs on one or more computers in one or more locations, in which the systems, components, and techniques described below can be implemented.

The neural network training system 100 is a system that obtains data specifying an initial, pre-trained generative neural network 110 and further trains (“fine-tunes”) the pre-trained neural network 110 using a reward function 120 to generate a fine-tuned generative neural network 150.

The neural network 110 is referred to as a “generative” neural network because the neural network 110 generates a new output example conditioned on a context input, i.e., instead of discriminating between existing output examples.

For example, the neural network 110 can be a language model neural network, i.e., an auto-regressive neural network that generates output sequences of tokens from a vocabulary, e.g., conditioned on a context sequence.

As a particular example, the tokens in the vocabulary can be text tokens, such that the language model neural network maps a context sequence of text tokens to an output sequence of text tokens.

As another particular example, the language model neural network can be a multimodal neural network, with the tokens in the context sequence including tokens representing another data modality, e.g., images, videos, or audio, instead of or in addition to text tokens.

The neural network 110 is referred to as an auto-regressive neural network because the neural network 110 auto-regressively generates an output sequence of tokens by generating each particular token in the output sequence conditioned on a current input sequence that includes any tokens that precede the particular text token in the output sequence, i.e., the tokens that have for already been generated for any previous positions in the output sequence that precede the particular position of the particular token, and a context input that provides context for the output sequence. For example, the current input sequence when generating a token at any given position in the output sequence can include the context sequence and the tokens at any preceding positions that precede the given position in the output sequence. As a particular example, the current input sequence can include the context sequence followed by the tokens at any preceding positions that precede the given position in the output sequence. Optionally, the context and the current output sequence can be separated by one or more predetermined tokens within the current input sequence.

More specifically, to generate a particular token at a particular position within an output sequence, the neural network 110 can process the current input sequence to generate a score distribution, e.g., a probability distribution, that assigns a respective score, e.g., a respective probability, to each token in the vocabulary of tokens. The neural network 110 can then select, as the particular token, a token from the vocabulary using the score distribution. For example, the neural network 110 can greedily select the highest-scoring token or can sample, e.g., using nucleus sampling or another sampling technique, a token from the distribution.

As a particular example, the language model neural network 110 can be an auto-regressive Transformer-based neural network that includes (i) a plurality of attention blocks that each apply a self-attention operation and (ii) an output subnetwork that processes an output of the last attention block to generate the score distribution.

The neural network 110 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022: J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021: Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoory Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners. arXiv preprint arXiv: 2005.14165, 2020.

Generally, however, the Transformer-based neural network includes a sequence of attention blocks (a block that applies an attention mechanism over a block input to generate a block output), and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

As described above, the language model neural network 110 has been pre-trained. For example, the system 100 or another training system can have pre-trained the language model neural network 110 on a language modeling task, e.g., a task that requires predicting, given a current sequence of text tokens, the next token that follows the current sequence in the training data. As a particular example, the language model neural network 110 can be pre-trained on a next token prediction objective, i.e., a maximum-likelihood objective on a large dataset of text, e.g., text that is publicly available from the Internet or another text corpus.

Generally, because the neural network 110 is auto-regressive, the system 100 can use the same neural network 110 to generate multiple different candidate output sequences in response to the same context sequence, e.g., by using beam search decoding from score distributions generated by the neural network 110, using a Sample-and-Rank decoding strategy, by using different random seeds for the pseudo-random number generator that's used in sampling for different runs through the neural network 110 or using another decoding strategy that leverages the auto-regressive nature of the neural network.

As one example, the reward function 120 can be a reward model. A reward model is a machine learning model, e.g., a neural network, that has been trained to process an input that includes (i) a context input and (ii) an output example generated by the generative neural network 110 for the context input to generate as output a reward score that measures the quality of the output example relative to the context input.

As a particular example, the reward model 120 can have been trained using reinforcement learning from human preferences (RLHF) or another appropriate supervised learning technique.

As another example, instead of being a learned model, the reward function can be a hard-coded function that evaluates the quality of an output example generated by the generative neural network 110. For example, when ground truth outputs for the context inputs are available, the reward function can be, e.g., a BLEU score function, an edit distance function, and so on. When ground truth output for context inputs are not available, the reward function can be, e.g., a textual coherence measure when the output examples are text or a non-reference image quality measure when the output examples are images.

While the above description generally describes the generative neural network 110 being a language model neural network that generates output examples that are output sequences, e.g., sequences of text tokens, the generative neural network 110 can be any appropriate type of generative model that can be used to generate multiple different output examples from any given context input and for which a reward function 120 is available to the system 100.

Other examples of such generative neural networks 110 include image or video generation neural networks, e.g., diffusion models, that generate images, audio or videos conditioned on context inputs, e.g., text, audio, categorical variables, or other images. These and other types of generative neural networks 110 are described in more detail below.

To improve the performance of the pre-trained neural network 110, the system 100 fine-tunes, i.e., further trains, the generative neural network 110 on a training data set 130 to generate a fine-tuned neural network 150.

The training data set 130 includes a set of context inputs, i.e., inputs for the task for which the reward function 120 has been trained.

In particular, the system 100 uses the reward function 120 to train the generative neural network 110 in an offline manner through reinforced self-training.

In particular, the training of the neural network 110 is referred to as “offline” because the system 100 trains the neural network 110 from the fixed training data set 130. That is, even though the system 100 performs the training over multiple training stages, the system 100 does not need to obtain any new context inputs at any of the multiple training stages.

The training is referred to as “self-training” because, at each training stage, the system 100 generates the training data for the training using the current version of the neural network 110 as of the training stage.

The training is referred to as “reinforced self-training” because the system performs multiple training stages and, at each training stage, improves the performance of the neural network 110 so that the training data for the next training stage is higher quality (where “quality” may be defined, e.g., by the reward score).

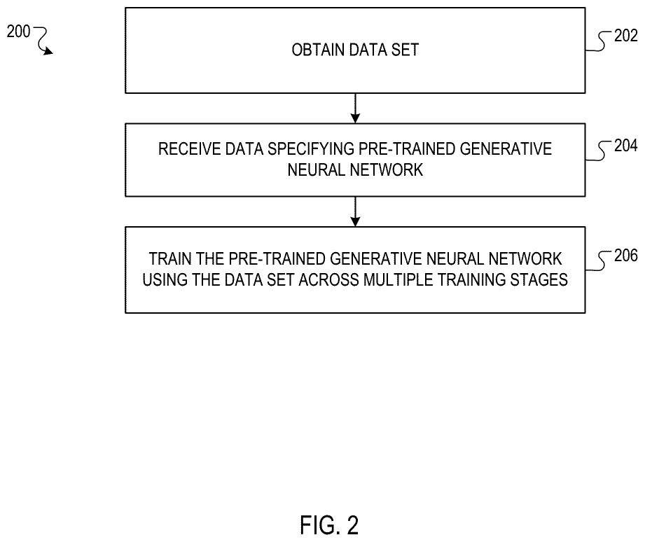

Fine-tuning the neural network 110 is described below with reference to FIGS. 2-5.

After training, the system 100 or another inference system deploys the fine-tuned language model neural network 150 for performing the task. As a result of the training performed by the system 100, the neural network 150 can, after training, perform the downstream task effectively even when only a limited number of context inputs are included in the training data set 130.

FIG. 2 is a flow diagram of an example process 200 for training a neural network. For convenience, the process 200 will be described as being performed by a system of one or more computers located in one or more locations. For example, a neural network training system, e.g., the neural network training system 100 of FIG. 1, appropriately programmed, can perform the process 200.

The system receives data specifying a training data set that includes a plurality of context inputs (step 202).

The system receives data specifying a pre-trained generative neural network (step 204).

For example, the generative neural network can have been trained by another system and the system can receive the pre-trained parameter values for the neural network from the other system. As a particular example, the generative neural network can be a pre-trained “foundation” model that is available for use by the system.

As another example, the data set can also include, for some or all of the context inputs, a respective ground truth output. In this example, the system can have pre-trained the neural network on the data set through supervised learning. That is, the system can have pre-trained the neural network on the context inputs and corresponding ground truth outputs to optimize a supervised learning objective, e.g., a maximum likelihood estimation (MLE) loss, a cross-entropy loss, a behavior cloning loss, or another appropriate supervised objective.

Merely as an example, a suitable MLE loss, [symbol] _{MLE}, for a dataset [symbol] and an autoregressive generative neural network with parameters θ that defines a conditional probability distribution π_{θ}(y|x)=Πₜ₌₀^{T}π_{θ}(yₜ|y_{0:t-1}, x) for an output example sequence y=(y₁, y₂, . . . , yₙ) and a context input sequence x=(x₁, x₂, . . . , xₙ), where tokens xᵢyᵢ are from a chosen vocabulary, can be determined as:

$${ℒ}_{MLE} = - {𝔼}_{( x , y ) - 𝒟} [ {\sum }_{t = 0}^{T} log {π}_{θ} ( {y}_{t} \vert {y}_{0 : t - 1} , x ) ]$$

The system further trains the pre-trained generative neural network using the data set across multiple training stages (step 206). That is, the system further trains the generative neural network to improve the quality of the outputs that are generated by the generative neural network.

At a high level, at each grow step, the system increases the size of the data set by generating additional outputs for some or all of the context inputs in the data set.

At each improve step, the system trains the neural network on a corresponding subset of the current dataset in order to improve the quality of the outputs. Performing training stages is described in more detail below.

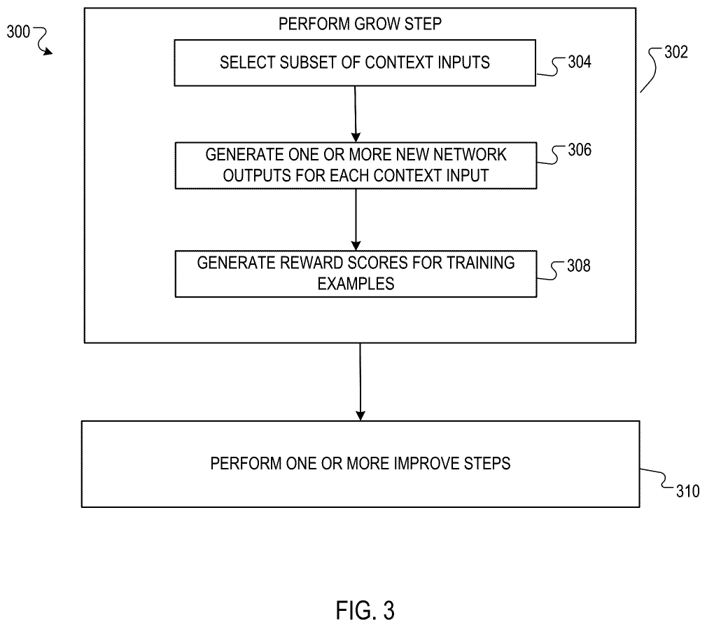

FIG. 3 is a flow diagram of an example process 300 for performing a training stage. For convenience, the process 300 will be described as being performed by a system of one or more computers located in one or more locations. For example, a neural network training system, e.g., the neural network training system 100 of FIG. 1, appropriately programmed, can perform the process 300.

As described above, the system can perform a sequence of multiple training stages to train the generative neural network.

That is, the system can perform a sequence of iterations of the process 300 during the training of the generative neural network.

At each training stage, the system performs a grow step (step 302).

During the grow step, the system selects a subset of the context inputs in the data set (step 304).

In some implementations, the subset is not a proper subset, i.e., the system selects all of the context inputs in the data set.

In some other implementations, the subset is a so-called proper subset and the system selects less than all of the context inputs in the data set. For example, the system can randomly sample a fixed number of context inputs from the data set.

The system then processes each of the context inputs in the subset using the generative neural network and in accordance with current values of the parameters of the generative neural network to generate one or more new output examples for each of the context inputs (step 306).

That is, the system uses the current values of the parameters of the generative neural network as of the current training stage to generate the new output example(s) for the context inputs.

When the current training stage is the first training stage, the current values are the pre-trained values of the parameters.

When the current training stage is not the first training stage, the current values are the values of the parameters after being updated at the preceding training stage.

As a particular example, the system can generate multiple different output examples for each context input using the neural network, e.g., by making use of the stochastic sampling described above.

Thus, the system generates, from the data set, a set of new training examples that each include a context input and an output example for the context input.

Sampling a large number of new output examples can be computationally expensive and, in some cases, e.g., when the generative neural network is a large model with a large inference cost, bottleneck the training process.

In some implementations, to account for this, the system can parallelize performing step 306 across multiple different hardware devices.

That is, the system can maintain a respective instance of the generative neural network on each of multiple sets of one or more hardware devices. Each set of hardware devices can include one or more hardware computing devices, e.g., one or more hardware accelerators, and optionally a general purpose processor, and typically memory. The hardware accelerators can each be computer chips that perform certain operations, e.g., matrix multiplication, in hardware. For example, the hardware accelerators can be tensor processing units (TPUs), graphics processing units (GPUs), or other machine learning accelerators that perform machine learning operations in hardware.

The system can then assign a mini batch of one or more context inputs to each set of hardware devices and generate, in parallel across the sets of hardware devices, one or more output examples for each context input in the mini batches using the respective instances of the generative neural network that are maintained by each of the sets of hardware devices.

If the total number of context inputs in the subset exceeds the total number of inputs in the mini batches assigned to the sets of hardware devices, the system can perform multiple iterations of this parallelized sampling during each grow step.

By parallelizing the sampling in this manner, the system can significantly decrease the time required to perform a grow step.

Instead of or in addition to the parallelization described above, the system can also leverage distillation to improve the speed of performing the grow step. As a particular example, prior to performing each grow step, the system can use distillation to distill the generative neural network as of the preceding training stage into a smaller, more computationally efficient model. For example, when the generative neural network is a Transformer neural network, the system can distill the Transformer neural network into a Transformer neural network that has fewer parameters or into a recurrent neural network (RNN) that has a shorter sampling time. The system can then use this computationally efficient model to generate the new training examples, e.g., also making use of the parallelization described above.

The system generates a respective reward score for each training example using a reward function (step 308).

As described above, the reward function can be a machine learning model, e.g., a neural network, that has been trained to process an input that includes (i) a context input and (ii) a output example to generate as output a reward score that measures the quality of the output example relative to the context input. As a particular example, the reward model can have been trained using reinforcement learning from human preferences (RLHF, see, e.g., Christiano et al., “Deep Reinforcement Learning from Human Preferences” arXiv: 1706.03741 17 Feb. 2023), or another appropriate supervised learning technique.

Thus, to generate the reward score for a given training example, the system processes an input that includes (i) the context input in the training example and (ii) the output example in the training example using the reward model to generate as output the reward score.

In some implementations, each set of hardware devices also maintains a respective instance of the reward model and uses the respective instance of the reward model to score the training examples that are generated by the set of hardware devices in the parallelized approach described above.

As a result of performing the grow step, the system generates an expanded training data set that includes a plurality of training examples and a respective reward score for each training example. When the system has access to one or more ground truth output examples for some or all of the context inputs, the system can also include the ground truth output examples for the context inputs in the expanded training data set. Some models, e.g., language and other models, may be trained to predict a next token in a sequence, and ground truth output examples for context inputs are not essential.

The system then performs one or more improve steps (step 310).

At each improve step, the system trains the neural network using the expanded data set generated by performing the grow step to update the values of the parameters of the neural network (step 312).

Generally, at each improve step, the system trains the generative neural network on the expanded training data set using the reward scores for the training examples in the expanded training data set

In particular, at the first improve step of a given training stage, the system trains the neural network starting from the values of the parameters determined at the end of the preceding training stage or, for the first training stage, from the pre-trained values of the parameters.

For any subsequent improve steps of a given training stage, the system trains the neural network starting from the values of the parameters determined at the end of the preceding improve step of the given training stage.

At each improve step, the system uses the reward scores generated by the reward function as part of the training in order to improve the performance of the neural network relative to the values of the parameters at the beginning of the improve step.

Generally, sampling from the neural network to perform a grow step is computationally expensive, particularly with large models with large numbers of parameters. In some implementations, to account for this, the system performs multiple improve steps at each training stage. Thus, the computationally expensive procedure is done only from a policy that has been trained after several improve steps. Thus, the system amortizes the cost of single dataset generation in multiple improve steps.

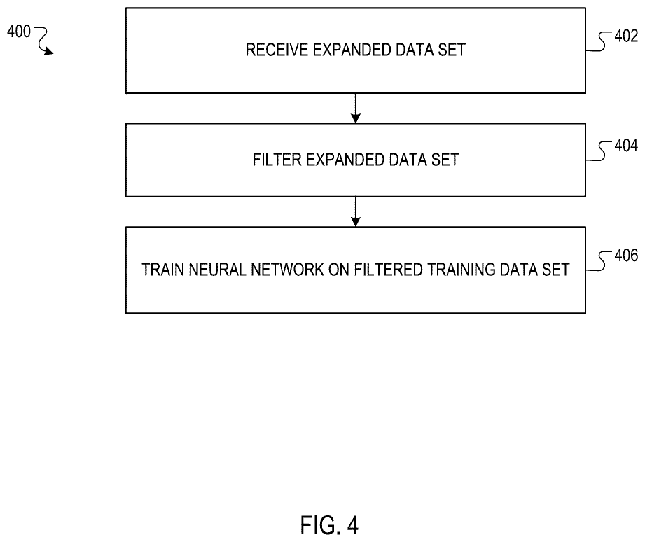

One example technique for performing an improve step is described in more detail below with reference to FIG. 4.

FIG. 4 is a flow diagram of an example process 400 for performing an improve step. For convenience, the process 400 will be described as being performed by a system of one or more computers located in one or more locations. For example, a neural network training system, e.g., the neural network training system 100 of FIG. 1, appropriately programmed, can perform the process 400.

The system receives an expanded training data set (step 402), i.e., the expanded training data set generated as a result of the grow step of the current training stage.

The system selects a corresponding subset of the expanded training data set for the improve step using a respective threshold value for the improve step. That is, each improve step at each training stage is associated with a respective threshold value and the system uses the respective threshold value for the improve step to select the corresponding subset for the improve step

For example, the system can filter the expanded training data set to remove the training examples that have a reward score that is below the respective threshold value for the improve step (step 404).

In other words, the system generates a filtered data set that includes only the training examples from the expanded training data set that have reward scores that exceed the threshold.

Generally, the system increases the thresholds for the improve steps as training progresses. That is, for any given improve step, the threshold for the given improve step (τᵢ) is higher than the threshold for any earlier improve step (τᵢ₋₁) at the same training stage and for any improve step at any preceding training stage (e.g., for N iterations the filtering thresholds may be τ_{N}>τ_{N-1}> . . . τ₁). For example, the system can increase the thresholds for the improve steps starting from a predetermined initial threshold value according to a schedule, e.g., a linear schedule that linearly increases the threshold or an exponential schedule that exponentially increases the threshold.

The system trains the neural network on the filtered data set (step 406).

The system can train the neural network on any of a variety of loss functions.

For example, the system can train the neural network on the same pre-training loss that was used for pre-training prior to the first training stage, e.g., using an appropriate supervised learning objective, e.g., a maximum likelihood estimation (MLE) loss, a cross-entropy loss, a behavior cloning loss, and so on.

As another example, the system can train the neural network using the reward scores to optimize any appropriate offline reinforcement learning objective.

Performing the data filtering by making use of increasing thresholds results in subsets of datasets with increasing quality but decreasing sizes at each improve step. In some cases, to prevent the generative neural network from overfitting, the system can decrease the learning rate when performing the training for each successive improve step.

Consecutively performing improve steps on higher quality data subsets ensures policy improvement even though the same initial fixed dataset is used to generate the training data for the same improve step.

While FIG. 4 describes the example where the system filters the expanded set to remove the training examples that have a reward score that is below the respective threshold value, in other examples the system uses the reward scores differently when selecting the corresponding subset. For example, the system can sample training examples from the expanded training data set in accordance with the respective threshold value for the improve step, i.e., so that training examples that have a reward score that is below the respective threshold value have a first probability of being sampled and training examples that have a reward score that is not below the respective threshold value have a second probability of being sampled, with the first probability being smaller than the second probability. As another example, the system can include, in the corresponding subset, the filtered data set generated as described above and a threshold number of randomly sampled training examples from the expanded set or from the portion of the expanded set that includes only the training examples that have reward scores that are below the threshold value.

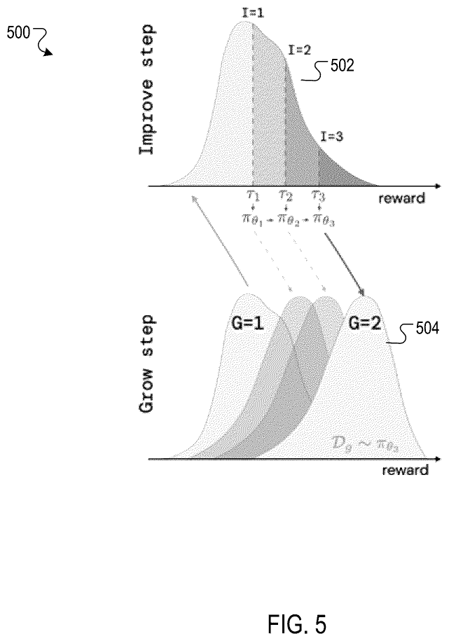

FIG. 5 shows the progression of the training of the neural network.

As shown in FIG. 5, after performing the first grow step (G=1) of the first training stage the system generates a data set that has the reward score distribution 502 shown in FIG. 5.

The system then performs three improve steps (I=1, I=2, I=3) with corresponding, increasing thresholds to generate parameter values θ₁, θ₂, and θ₃.

As can be seen from FIG. 5, if a new expanded data set were generated after each of the three improve steps as described above, the new expanded data sets would have increasingly positive reward distributions.

After the third improve step, the system begins the second training stage by performing a second grow step (G=2) to generate a new expanded data set 504 that has a significantly more positive reward score distribution than the reward score distribution 502.

Thus, by repeatedly performing training stages, the system trains the neural network on increasingly higher-quality data sets, thereby iteratively improving the performance of the trained neural network.

By performing multiple improve steps per training stage, the system amortizes the computational cost of the computationally expensive grow steps while continuing to improve the performance of the neural network. That is, the system reduces the total number of grow steps that need to be performed during the training stage in order to achieve high quality performance, thereby improving the computational efficiency of the training process.

Merely as illustrations, some further example uses of the above techniques are now described. In general the above techniques can be used to implement a wide range of machine learning tasks.

In some implementations, but not essentially, one or both of the context input and the output example may be defined by a sequence of tokens, e.g., from a vocabulary of tokens, that represent the context input and the output example. For example the tokens may comprise tokens representing text such as words or wordpieces in a natural language, or values or acoustic features of an audio waveform, or values of pixels of a still or moving image (which as used herein includes points of a LIDAR point cloud). In some implementations the context input may comprise tokens representing observations of an environment, e.g., a real world environment, of an agent, e.g., a mechanical agent, and the output example may include tokens that represent actions to be performed by the agent.

For example in some implementations the generative neural network may implement a sequence-to-sequence model that processes an input sequence of tokens to provide an output sequence of tokens. In some implementations one or both of the context input and the output example comprise data in some other format. For example the context input may comprise an embedding of one or more of the aforementioned data types; and the output example may comprise data representing, e.g., text, audio, image pixels, or actions that is not tokenized.

Where the neural network 110 comprises a language model neural network the context input may represent a sequence of text in one language and the output example can be a translation of the sequence of text into another language, i.e., a sequence of text in the other language that is a translation of the input sequence of text. In some implementations neural network 110 may be trained to perform a multi-lingual machine translation task, i.e., to translate between multiple different source language-target language pairs (in which case the context input may be augmented with an identifier that indicates the target language).

In some implementations the neural network 110 comprises a language model neural network models a computer language, e.g., an interpreted or complied high level language, or a markup language, or machine code. The context input may represent a sequence of text in the computer language, i.e., computer code, e.g., a computer program, and the output example may represent a sequence of text in a natural language that describes the operation of the code: or the context input may represent a sequence of text in a natural language that specifies the operation of a computer program or other computer code, and the output example may represent a sequence of text in the computer language, i.e., computer code, that operates as specified.

In some applications the generative neural network 110 comprises an audio, image or video generation model or a multimodal model. The output example may then comprises one or both of audio data representing an audio waveform and image data representing pixels of a still or moving image. The context input may defines characteristics of the output example, e.g., describing the output example to be generated. For example the context input may comprise text in a natural language, e.g., as a sequence of tokens, that defines, e.g., describes, a target content of the output example such as an image, audio, or video to be generated. Or context input may comprise an image, audio, or video, and the output example may describe one or more characteristics of the context input.

Where the context input comprises text in a natural language the output example may comprise audio data that represents a spoken utterance of the text in the natural language. As another example, where the context input comprises audio data, e.g., a sequence of tokens, for a spoken utterance in a natural language the output example may represent text, e.g., as a sequence of tokens, that is a transcription of the spoken utterance in the natural language.

The generative neural network 110 may comprise a multimodal model, that is configured to process a context input and/or generate an output example that includes data of multiple different types, e.g., two or more of data representing text in a natural language, audio, still or moving images, observations of an environment, and actions for an agent, e.g., represented as tokens as previously described. Such a multimodal model may, e.g., convert between different input and output modes, e.g., text/image/audio, e.g., for captioning, or otherwise classifying (into one of a set of classes) or characterizing an image or audio input, or by answering a question related to the image or audio input, e.g., relating to a future, e.g., a physical prediction of a state of objects represented by the image or audio, or by generating data representing an image or audio in answer to a text, audio, or visual question represented by the context input.

The generative neural network 110 may comprise a neural network configured to perform an agent control task.

For example the context input may comprise data, e.g., tokens, that represent a sequence of one or more observations characterizing states of an environment, and the output example may comprise data that defines an action to be performed by the agent in response to the most recent data in the sequence.

As one example, the agent may be a mechanical agent, e.g., a robot, acting in a real-world environment to perform a task: the observations may comprise any type of observations, e.g., observations from one or more sensors of the environment, such as an image sensor or a sensor of a position, state or configuration of the agent. The output example may comprise control signals, e.g., tokens that represent control signals, used to control the agent to perform the task, e.g., to control position, velocity, or acceleration of the agent, e.g., for navigation, or of parts of the agent, e.g., for object manipulation. Optionally the context input may include other information, e.g., textual tokens for text defining the task to be performed. Such a task may be, e.g., to locate or manipulate an object of interest in the environment or to move an object of interest to a specified location in the environment or to navigate to a specified destination in the environment. In another example the agent may be a human agent and the actions may comprise instructions, e.g., actions that generate text, audio, and/or visual instructions, to the human to perform the task. For example a digital assistant may include one or more sensors such as a camera that capture observations of the human user, and can use the generative neural network 110 to generate actions in response to the observations, e.g., action tokens, that represent instructions to the user to perform a particular task, to guide the user through the task. The task may, e.g., be defined by text in a natural language in the context input, e.g., encoded as text tokens.

As another example, the agent may be a simulated agent acting in a simulated environment. That is, the environment may be a simulated environment, e.g., a video game or a simulator of a real-world environment, generated by one or more software programs and the agent may be a simulated agent interacting within the simulated environment.

As another example, the agent may be a computer control agent that controls one or more software applications executing on one or more computers. For example, the agent can perform actions that are commands for interacting with the one or more software applications. The software applications can be, e.g., applications on smartphones, tablets, or other mobile devices, applications on a different type of user computer, or application executing one on or more server computers. The commands can be, e.g., virtual input device commands, e.g., virtual mouse or keyboard commands, or calls to an application programming interface (API) or a combination of the two.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method, the method comprising:
receiving a training data set for training a generative neural network, wherein:
   the generative neural network has a plurality of parameters and is configured to receive as input a context input and to process the network input in accordance with the network parameters to generate an output example, and
   the training data set comprises a plurality of training context inputs:
training the generative neural network starting from initial values of the network parameters by performing a sequence of a plurality of training stages, the training comprising, for each training stage:
   generating an expanded training data set for the training stage, comprising:
      for each training context input in a subset of the training context inputs in the training data set, processing the training context input using the generative neural network and in accordance with current values of the network parameters as of the training stage to generate a set of one or more output examples:
      for each training context input in the subset of the training context inputs in the training data set and for each output example in the set, generating a respective training example that comprises the training context input and the output example:
      for each respective training example, processing the training context input and the output example in the training example using a reward function to generate a reward score for the training example; and
      including, in the expanded training data set, the respective training examples; and
   performing a sequence of one or more improve steps, wherein performing each improve step comprises:
   training the generative neural network on the training examples in a corresponding subset of the expanded training data set using the reward scores for the training examples in the corresponding subset.

Embodiment 2 is the method of embodiment 1, wherein the method is implemented in a parallel processing system comprising a plurality of sets of one or more hardware devices, each set of hardware devices comprising one or more hardware computing devices, wherein the sets of hardware devices are configured to operate in parallel, the method further comprising:
maintaining a respective instance of the generative neural network on each of the sets of hardware devices; and
wherein generating the expanded training data set for the training stage further comprises:
apportioning each training context input in the subset of the training context inputs to a respective one of the sets of hardware devices; and
processing each training context input using the generative neural network on the respective set of one or more hardware devices to generate a respective one of the output examples:
wherein the set of output examples comprises a plurality of output examples generated by processing the training context inputs in parallel using the plurality of sets of hardware devices.

Embodiment 3 is the method of embodiment 2, wherein apportioning each training context input in the subset of the training context inputs to a respective one of the sets of hardware devices further comprises:
determining batches of the training context inputs, each batch comprising one or more training context inputs; and
assigning each batch of training context inputs to a respective one of the sets of hardware devices.

Embodiment 4 is the method of embodiment 2 or 3, wherein the reward function is defined by a reward model neural network, the method further comprising:
maintaining a respective instance of the reward model neural network on each of the sets of hardware devices; and
wherein processing each training context input using the generative neural network on the respective set of one or more hardware devices to generate a respective one of the output examples further comprises:
processing the respective one of the output examples and the training context input for the respective one of the output examples using the reward model neural network on the respective set of one or more hardware devices to generate a reward score for the training example.

Embodiment 5 is the method of any one of embodiments 1-4, wherein the initial values of the network parameters have been determined by pre-training the generative neural network on a pre-training data set.

Embodiment 6 is the method of any one of embodiments 1-5, wherein the set of output examples includes a plurality of output examples.

Embodiment 7 is the method of any one of embodiments 1-6, wherein the subset of the training context inputs in the training data set includes all of the training context inputs in the training data set.

Embodiment 8 is the method of any one of embodiments 1-7, wherein the sequence of improve steps includes a plurality of improve steps.

Embodiment 9 is the method of embodiment 8, wherein training the generative neural network on the training examples in a corresponding subset of the expanded training data set using the reward scores for the training examples in the corresponding subset comprises:
for the first improve step at the training stage, training the generative neural network starting from the current values of the network parameters as of the training stage; and
for each improve step after the first improve step, training the generative neural network starting from the values of the network parameters determined by performing the preceding improve step.

Embodiment 10 is the method of any one of embodiments 1-9, for the first training stage, the current values of the network parameters as of the training stage are the initial values; and
for each training stage after the first training stage, the current values of the network parameters as of the training stage are values of the network parameters determined by performing the last improve step at a preceding training stage.

Embodiment 11 is the method of any one of embodiments 1-10, wherein each improve step at each training stage is associated with a respective threshold value, and wherein the method further comprises:
selecting the corresponding subset for each improve step using the respective threshold value for the improve step.

Embodiment 12 is the method of embodiment 11, wherein selecting the corresponding subset for each improve step using the respective threshold value for the improve step comprises selecting only the training examples having respective reward scores above the respective threshold value for the improve step.

Embodiment 13 is the method of any one of embodiments 11-12, wherein selecting the corresponding subset for each improve step using the respective threshold value for the improve step comprises sampling training examples in accordance with the respective threshold value for the improve step.

Embodiment 14 is the method of any one of embodiments 11-13, wherein, for each improve step, the respective threshold value is higher than the respective threshold values for any preceding improve steps at the same training stage.

Embodiment 15 is the method of embodiment 14, wherein, for each improve step, the respective threshold value is higher than the respective threshold values for any improve step at any preceding training stage.

Embodiment 16 is the method of any one of embodiments 1-15, wherein the generative neural network is a language model neural network and each output example is a respective sequence of tokens from a vocabulary.

Embodiment 17 is the method of any one of embodiments 1-16, wherein the generative neural network comprises an audio, image or video generation model or a multimodal model: wherein the output example comprises one or both of audio data representing an audio waveform and image data representing pixels of a still or moving image; and wherein the context input defines characteristics of the output example.

Embodiment 18 is the method of any one of embodiments 1-17, wherein the generative neural network comprises an agent control model: wherein the output example comprises action selection data that defines one or more actions to be implemented by an agent to perform a task; and wherein the context input defines the task to be performed.

Embodiment 19 is a system comprising one or more computers and one or more storage devices storing instructions that when executed by the one or more computers cause the one more computers to perform the operations of the respective method of any one of embodiments 1-18.

Embodiment 20 is one or more computer storage media storing instructions that when executed by one or more computers cause the one more computers to perform the operations of the respective method of any one of embodiments 1-18.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a training data set for training a generative neural network, wherein:
the generative neural network has a plurality of parameters and is configured to receive as input a context input and to process the network input in accordance with the network parameters to generate an output example, and
the training data set comprises a plurality of training context inputs:
training the generative neural network starting from initial values of the network parameters by performing a sequence of a plurality of training stages, the training comprising, for each training stage:
generating an expanded training data set for the training stage, comprising:
for each training context input in a subset of the training context inputs in the training data set, processing the training context input using the generative neural network and in accordance with current values of the network parameters as of the training stage to generate a set of one or more output examples:
for each training context input in the subset of the training context inputs in the training data set and for each output example in the set, generating a respective training example that comprises the training context input and the output example:
for each respective training example, processing the training context input and the output example in the training example using a reward function to generate a reward score for the training example; and
including, in the expanded training data set, the respective training examples; and
performing a sequence of one or more improve steps, wherein performing each improve step comprises:
training the generative neural network on the expanded training data set using the reward scores for the training examples in the expanded training data set.

2. The method of claim 1, wherein the method is implemented in a parallel processing system comprising a plurality of sets of one or more hardware devices, each set of hardware devices comprising one or more hardware computing devices, wherein the sets of hardware devices are configured to operate in parallel, the method further comprising:
maintaining a respective instance of the generative neural network on each of the sets of hardware devices; and
wherein generating the expanded training data set for the training stage further comprises:
apportioning each training context input in the subset of the training context inputs to a respective one of the sets of hardware devices; and
processing each training context input using the generative neural network on the respective set of one or more hardware devices to generate a respective one of the output examples:
wherein the set of output examples comprises a plurality of output examples generated by processing the training context inputs in parallel using the plurality of sets of hardware devices.

3. The method of claim 2, wherein apportioning each training context input in the subset of the training context inputs to a respective one of the sets of hardware devices further comprises:
determining batches of the training context inputs, each batch comprising one or more training context inputs; and
assigning each batch of training context inputs to a respective one of the sets of hardware devices.

4. The method of claim 2, wherein the reward function is defined by a reward model neural network, the method further comprising:
maintaining a respective instance of the reward model neural network on each of the sets of hardware devices; and
wherein processing each training context input using the generative neural network on the respective set of one or more hardware devices to generate a respective one of the output examples further comprises:
processing the respective one of the output examples and the training context input for the respective one of the output examples using the reward model neural network on the respective set of one or more hardware devices to generate a reward score for the training example.

5. The method of claim 1, wherein the initial values of the network parameters have been determined by pre-training the generative neural network on a pre-training data set.

6. The method of claim 1, wherein the set of output examples includes a plurality of output examples.

7. The method of claim 1, wherein the subset of the training context inputs in the training data set includes all of the training context inputs in the training data set.

8. The method of claim 1, wherein the sequence of improve steps includes a plurality of improve steps.

9. The method of claim 8, wherein training the generative neural network on the expanded training data set comprises:
for the first improve step at the training stage, training the generative neural network starting from the current values of the network parameters as of the training stage; and
for each improve step after the first improve step, training the generative neural network starting from the values of the network parameters determined by performing the preceding improve step.

10. The method of claim 1, wherein:
for the first training stage, the current values of the network parameters as of the training stage are the initial values; and
for each training stage after the first training stage, the current values of the network parameters as of the training stage are values of the network parameters determined by performing the last improve step at a preceding training stage.

11. The method of claim 1, wherein each improve step at each training stage is associated with a respective threshold value, and wherein training the generative neural network on the expanded training data set comprises, for each improve step:
selecting a corresponding subset of the expanded training data set for the improve step using the respective threshold value for the improve step; and
training the generative neural network only on the training examples in the corresponding subset.

12. The method of claim 11, wherein selecting the corresponding subset for the improve step using the respective threshold value for the improve step comprises selecting only the training examples having respective reward scores above the respective threshold value for the improve step.

13. The method of claim 11, wherein selecting the corresponding subset for the improve step using the respective threshold value for the improve step comprises sampling training examples in accordance with the respective threshold value for the improve step.

14. The method of claim 11, wherein, for each improve step, the respective threshold value is higher than the respective threshold values for any preceding improve steps at the same training stage.

15. The method of claim 14, wherein, for each improve step, the respective threshold value is higher than the respective threshold values for any improve step at any preceding training stage.

16. The method of claim 1, wherein the generative neural network is a language model neural network and each output example is a respective sequence of tokens from a vocabulary.

17. The method of claim 1, wherein the generative neural network comprises an audio, image or video generation model or a multimodal model: wherein the output example comprises one or both of audio data representing an audio waveform and image data representing pixels of a still or moving image; and wherein the context input defines characteristics of the output example.

18. The method of claim 1, wherein the generative neural network comprises an agent control model: wherein the output example comprises action selection data that defines one or more actions to be implemented by an agent to perform a task; and wherein the context input defines the task to be performed.

19. One or more computer-readable storage media storing instructions that when executed by one or more computers cause the one or more computers to perform operations comprising:
receiving a training data set for training a generative neural network, wherein:
the generative neural network has a plurality of parameters and is configured to receive as input a context input and to process the network input in accordance with the network parameters to generate an output example, and
the training data set comprises a plurality of training context inputs:
training the generative neural network starting from initial values of the network parameters by performing a sequence of a plurality of training stages, the training comprising, for each training stage:
generating an expanded training data set for the training stage, comprising:
for each training context input in a subset of the training context inputs in the training data set, processing the training context input using the generative neural network and in accordance with current values of the network parameters as of the training stage to generate a set of one or more output examples:
for each training context input in the subset of the training context inputs in the training data set and for each output example in the set, generating a respective training example that comprises the training context input and the output example:
for each respective training example, processing the training context input and the output example in the training example using a reward function to generate a reward score for the training example; and
including, in the expanded training data set, the respective training examples; and
performing a sequence of one or more improve steps, wherein performing each improve step comprises:
training the generative neural network on the training examples in a corresponding subset of the expanded training data set using the reward scores for the training examples in the corresponding subset.

20. A system comprising:
one or more computers; and
one or more storage devices storing instructions that, when executed by the one or more computers, cause the one or more computers to perform operations comprising:
receiving a training data set for training a generative neural network, wherein:
the generative neural network has a plurality of parameters and is configured to receive as input a context input and to process the network input in accordance with the network parameters to generate an output example, and
the training data set comprises a plurality of training context inputs:
training the generative neural network starting from initial values of the network parameters by performing a sequence of a plurality of training stages, the training comprising, for each training stage:
generating an expanded training data set for the training stage, comprising:
for each training context input in a subset of the training context inputs in the training data set, processing the training context input using the generative neural network and in accordance with current values of the network parameters as of the training stage to generate a set of one or more output examples:
for each training context input in the subset of the training context inputs in the training data set and for each output example in the set, generating a respective training example that comprises the training context input and the output example:
for each respective training example, processing the training context input and the output example in the training example using a reward function to generate a reward score for the training example; and
including, in the expanded training data set, the respective training examples; and
performing a sequence of one or more improve steps, wherein performing each improve step comprises:
training the generative neural network on the training examples in a corresponding subset of the expanded training data set using the reward scores for the training examples in the corresponding subset.
